(19) United States
(12) Patent Application Publication
(10) Pub. No.: US 2025/0390364 A1
(43) Pub. Date: Dec. 25, 2025

(54) ELECTRONIC DEVICE, METHOD AND STORAGE MEDIUM

(71) Applicant: CASIO COMPUTER CO., LTD., Tokyo (JP)

(72) Inventors: Naoko NIKAIDO, Tokyo (JP); Kosuke HASEGAWA, Tokyo (JP)

(21) Appl. No.: 19/240,123

(22) Filed: Jun. 17, 2025

(30) Foreign Application Priority Data
Jun. 20, 2024 (JP) 2024-099531

(51) Int. Cl. G06F 9/54; G06Q 10/1093; H04W 4/029

(52) U.S. Cl. CPC G06F 9/542; G06Q 10/1093; H04W 4/029

(57) ABSTRACT

An electronic device includes a display, a communicator that communicates with an external communication device, and at least one processor. The processor determines a notification that is to be displayed on the display from among notifications received by the communicator from the external communication device based on a priority of each of the notifications, the priority being determined based on user information related to a situation and/or an action history of a user of the electronic device, and displays the determined notification on the display.

### REFERENCE TO RELATED APPLICATIONS

This application is based upon and claims the benefit of priority from the prior Japanese Patent Application No. 2024-099531, filed on Jun. 20, 2024, the entire contents of which are incorporated herein by reference.

### TECHNICAL FIELD

The present disclosure relates to an electronic device, a method and a storage medium.

### DESCRIPTION OF RELATED ART

There is a known technology of an electronic device having a display, such as a wristwatch, displaying a notification received from an external communication device, such as a smartphone, on the display (e.g., JP 2023-86419 A). This type of electronic device usually displays the latest notification received from the communication device on the display.

### SUMMARY OF THE INVENTION

According to an aspect of the present disclosure, there is provided an electronic device including:
a display;
a communicator that communicates with an external communication device; and
at least one processor that
   determines a notification that is to be displayed on the display from among notifications received by the communicator from the external communication device based on a priority of each of the notifications, the priority being determined based on user information related to a situation and/or an action history of a user of the electronic device, and
   displays the determined notification on the display.

### BRIEF DESCRIPTION OF DRAWINGS

FIG. 1 illustrates a configuration of a communication system.

FIG. 2 is a block diagram illustrating a functional configuration of an electronic timepiece.

FIG. 3 is a block diagram illustrating a functional configuration of a smartphone.

FIG. 4 illustrates a display of the electronic timepiece displaying a notification.

FIG. 5 illustrates category priorities in each priority pattern.

FIG. 6 is a flowchart illustrating a control procedure for a notification transmission process.

FIG. 7 is a flowchart illustrating a control procedure for an individual priority determination process.

FIG. 8 is a flowchart illustrating a control procedure for a notification display process.

FIG. 9 is a flowchart illustrating a control procedure for a category priority determination process.

FIG. 10 illustrates examples of received notifications and their category priorities and individual priorities.

FIG. 11 illustrates overall priorities determined for the notifications in FIG. 10.

FIG. 12 illustrates examples of received notifications and their category priorities and individual priorities.

FIG. 13 illustrates overall priorities determined for the notifications in FIG. 12.

FIG. 14 is a flowchart illustrating a control procedure for the individual priority determination process in a second embodiment.

### DETAILED DESCRIPTION

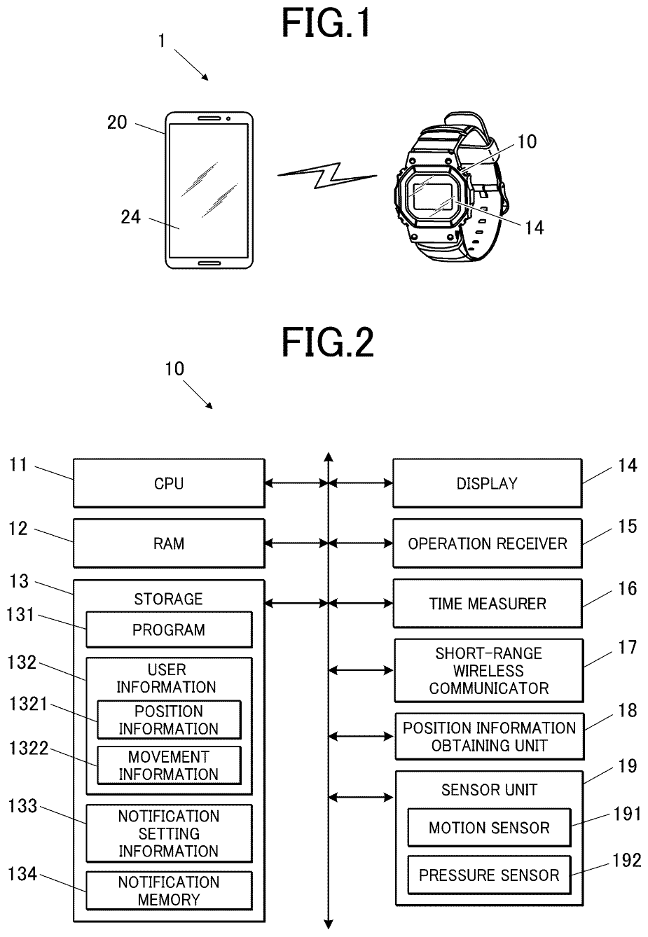

Hereinafter, a first embodiment of the present disclosure will be described with reference to the drawings. As illustrated in FIG. 1, a communication system 1 of this embodiment includes an electronic timepiece 10 (electronic device) and a smartphone 20 (communication device). The electronic timepiece 10 is a wristwatch (wearable device) that is worn on a wrist of a user. The smartphone 20 is carried and used by the user same as that of the electronic timepiece 10.

The electronic timepiece 10 is communicatively connected with the smartphone 20 by short-range wireless communication to perform data communication therewith. In this embodiment, Bluetooth® Low Energy (BLE) is used as the short-range wireless communication. However, another method of short-range wireless communication may be used. The electronic timepiece 10 and the smartphone 20 operate in cooperation with one another by transmitting and receiving data therebetween in the state of being communicatively connected with one another by BLE. For example, the electronic timepiece 10 receives time information from the smartphone 20 at predetermined timings per day (e.g., four times per day, i.e., every six hours on each day) to correct the internal time. Settings (settings of alarm time, world time, etc.) made for the electronic timepiece 10 on a cooperative application program installed in the smartphone 20 can be reflected in the electronic timepiece 10 that is communicatively connected with the smartphone 20. Notifications generated on various application programs, which hereinafter may be referred to as “applications”, installed in the smartphone 20 are transmitted to the electronic timepiece 10 and displayed on a display 14 of the electronic timepiece 10. The electronic timepiece 10 can operate in an activity mode for assisting the user in performing an activity as well as in a normal mode for displaying the date and time. In the activity mode, the electronic timepiece 10 calculates index values that indicate the state of an activity (e.g., a pace, a pitch, etc. of running) that the user is performing, and displays information on the index values on the display 14. Examples of the activity include running, walking, and cycling (moving by bicycle).

As illustrated in FIG. 2, the electronic timepiece 10 includes a central processing unit (CPU) 11, a random access memory (RAM) 12, a storage 13, the aforementioned display 14, an operation receiver 15, a time measurer 16, a short-range wireless communicator 17 (communicator), a position information obtaining unit 18, and a sensor unit 19. These components of the electronic timepiece 10 are connected with one another via a data transmission path, such as a bus.

The CPU 11 is a processor functioning as a controller that controls operation of the electronic timepiece 10 by reading and executing programs 131 stored in the storage 13 and performing various types of arithmetic processing. The electronic timepiece 10 may have two or more processors (e.g., two or more CPUs), and the processors may perform processes that the CPU 11 performs in this embodiment. In this case, the processors constitute the controller. The processors may be involved in the same process(es), or independently perform different processes in parallel. The RAM 12 provides a working memory space for the CPU 11 and stores temporary data.

The storage 13 is a non-transitory storage medium readable by the CPU 11 as a computer and stores the programs 131 and various data. The storage 13 has a nonvolatile memory, such as a flash memory. The programs 131 are stored in the storage 13 in the form of computer-readable program codes. The data stored in the storage 13 includes user information 132, notification setting information 133, and a notification memory 134. Of these, the user information 132 includes position information 1321 and movement information 1322. The position information 1321 is information on the position of the electronic timepiece 10 (i.e., on the position of the user wearing the electronic timepiece 10) obtained by the position information obtaining unit 18. The movement information 1322 is information on the movement of the user (user movement) estimated by the CPU 11 on the basis of output data of the sensor unit 19 (motion information on the user motion) and/or the position information 1321. The position information 1321 and the movement information 1322 are forms of information related to the situation of the user. The notification setting information 133 is setting data that is referenced in a process(es) of determining priorities of notifications described later. The notification memory 134 temporarily stores the contents of notifications transmitted from the smartphone 20. In this embodiment, the notification memory 134 can store the contents of ten notifications.

The display 14 displays information, such as the time, date, day of the week, and notifications mentioned above, in a digital format in accordance with control signals transmitted from the CPU 11. The display 14 includes a display panel, such as a liquid crystal panel, capable of performing dot-matrix display, and a driving circuit for the display panel. In this embodiment, a memory-in-pixel (MIP) liquid crystal panel is used as the display panel. The MIP liquid crystal panel has, in each pixel, a memory (e.g., static RAM) that stores a pixel value indicating a display gray level. This memory in each pixel allows a still image to continue to be displayed without periodical writing of pixel values. This can reduce power consumption.

The operation receiver 15 includes operation elements, such as an operation button(s) and a crown, and outputs operation signals corresponding to operations on the operation elements to the CPU 11. The operation receiver 15 may include another operation element, such as a touchscreen superimposed on the display screen of the display 14.

The time measurer 16 includes an oscillator circuit, a frequency divider circuit, and a time measurement circuit. In the time measurer 16, a clock signal generated by the oscillator circuit is divided into signals by the frequency divider circuit, and the signals are counted by the time measurement circuit, so that the current date and time are calculated and retained.

The short-range wireless communicator 17 is a communication module including an antenna, a modulation-and-demodulation circuit, and a signal processing circuit, and performs the short-range wireless communication by BLE with the smartphone 20.

The position information obtaining unit 18 calculates the current position by receiving and decoding radio waves transmitted from positioning satellites of the global navigation satellite system (GNSS), such as the global positioning system (GPS). The position information obtaining unit 18 calculates the current position under the control of the CPU 11 and outputs the result to the CPU 11.

The sensor unit 19 includes a motion sensor 191 and a pressure sensor 192, and outputs data detected by each sensor to the CPU 11. The motion sensor 191 includes a three-axis acceleration sensor and a three-axis angular velocity sensor. The motion sensor 191 detects acceleration and angular velocity generated in the electronic timepiece 10 according to the motion of the user's wrist, and outputs the detected data to the CPU 11. The pressure sensor 192 is, for example, a semiconductor pressure sensor that makes use of the piezoresistive effect, and detects the magnitude of atmospheric pressure. The CPU 11 calculates the altitude on the basis of the detection result by the pressure sensor 192.

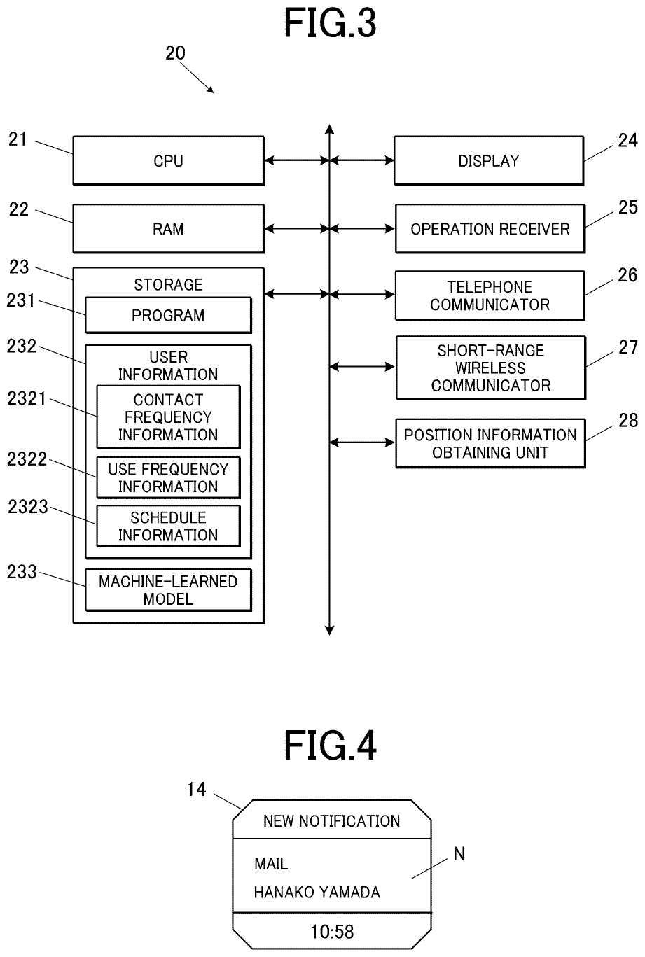

As illustrated in FIG. 3, the smartphone 20 includes a CPU 21, a RAM 22, a storage 23, a display 24, an operation receiver 25, a telephone communicator 26, a short-range wireless communicator 27, and a position information obtaining unit 28. These components of the smartphone 20 are connected with one another via a data transmission path, such as a bus.

The CPU 21 is a processor that controls operation of the smartphone 20 by reading and executing programs 231 stored in the storage 23 and performing various types of arithmetic processing. The smartphone 20 may have two or more processors (e.g., two or more CPUs), and the processors may perform processes that the CPU 21 performs in this embodiment. The processors may be involved in the same process(es), or independently perform different processes in parallel. The RAM 22 provides a working memory space for the CPU 21 and stores temporary data.

The storage 23 is a non-transitory storage medium readable by the CPU 21 as a computer and stores the programs 231 and various data. The storage 23 has a nonvolatile memory, such as a flash memory. The programs 231 are stored in the storage 23 in the form of computer-readable program codes. The programs 231 include various applications mentioned above. The data stored in the storage 23 includes user information 232 and a machine-learned model 233. The user information 232 includes contact frequency information 2321, use frequency information 2322, and schedule information 2323. Of these, the contact frequency information 2321 is information on the contact frequency between the user and each of a predetermined number of objects (e.g., other smartphone users) through an email application, a messaging application, and so forth. The contact frequency information 2321 may include information on the contact frequency in each time period. The use frequency information 2322 is information on the use frequency of each application by the user. The use frequency information 2322 may include information on the use frequency in each time period. The contact frequency information 2321 and the use frequency information 2322 are forms of information related to the history of actions (action history) of the user. The schedule information 2323 is information on the user's schedule registered in a schedule application. The schedule information 2323 is a form of the information related to the situation of the user. The machine-learned model 233 has been machine-learned to output the priority of a generated notification by receiving data of the notification. The machine-learned model 233 is not used in the first embodiment but used in a second embodiment described later. The machine-learned model 233 will be described in detail in the second embodiment. The machine-learned model 233 may be omitted from the smartphone 20 of the first embodiment.

The display 24 includes a display panel, such as a liquid crystal panel, capable of performing dot-matrix display, and a driving circuit for the display panel. The display 24 displays various menus, application screens, and so forth in accordance with control signals transmitted from the CPU 21.

The operation receiver 25 includes operation elements, such as operation buttons and a touchscreen superimposed on the display panel of the display 24, and outputs operation signals corresponding to operations on the operation elements to the CPU 21.

The telephone communicator 26 is a communication module including an antenna, a modulation-and-demodulation circuit, and a signal processing circuit, and communicates with mobile phone base stations or the like to transmit and receive voice data in telephone communication and packet data related to the Internet connection.

The short-range wireless communicator 27 is a communication module including an antenna, a modulation-and-demodulation circuit, and a signal processing circuit, and performs the short-range wireless communication by BLE with the electronic timepiece 10.

The position information obtaining unit 28 calculates the current position by receiving and decoding radio waves transmitted from positioning satellites of the global positioning satellite system, such as GPS. The position information obtaining unit 28 calculates the current position under the control of the CPU 21 and outputs the result to the CPU 21. One of the position information obtaining unit 18 of the electronic timepiece 10 and the position information obtaining unit 28 of the smartphone 20 may be omitted, and the position information obtained by the other thereof may be shared between the electronic timepiece 10 and the smartphone 20 through the short-range wireless communication.

Next, operation of the communication system 1 will be described. As described above, when a notification is generated in the smartphone 20, data of the notification is transmitted to the electronic timepiece 10 by the short-range wireless communication, and the notification is displayed on the display 14 of the electronic timepiece 10. As illustrated in FIG. 4, the electronic timepiece 10 is a small electronic device, and accordingly the display 14 has a very small display area as compared with the display 24 of the smartphone 20. The resolution of the display 14 is, for example, about 100 to 200 pixels in both length and width. As illustrated in FIG. 4, on the display 14 of such a size, a notification N is displayed so as to occupy the display area of the display 14. In the present disclosure, the “occupy” means occupying most of the display area of the display 14, which includes not only occupying the entire display area of the display 14, but also occupying at least half of the display area of the display 14. From another perspective, the “occupy” indicates a display form in which indications by other functions of the electronic timepiece 10 (e.g., indications by functions other than a simple indication of the time illustrated in FIG. 4) is once restricted by the notification N. In a predetermined restriction-imposed form, the maximum number of notifications N displayable at a time on the display 14 of such a size is limited to a predetermined number of notifications N of three or less. In this embodiment, as illustrated in FIG. 4, the maximum number of notifications N displayable at a time is one. The restriction-imposed form is a display form in which the amount of information is reduced within a range in which an overview of a notification N can be conveyed to the user. The restriction-imposed form may contain, for example, information on the category of a notification N and part of the contents of the notification N. In the example illustrated in FIG. 4, the notification N displayed in the restriction-imposed form contains “MAIL”, which indicates the category (email) of the notification N, and the sender name (HANAKO YAMADA) of the email, which is part of the contents of the notification N.

There has been used, as a method for displaying notifications N (e.g., one by one) on an electronic timepiece that can operate in cooperation with a smartphone, a method of displaying notifications N in order of new arrival, i.e., always displaying the latest notification N (notification N received last). However, if a large number of notifications N are received from the smartphone 20 in a short time, the method of simply displaying the latest notification N cannot display all the received notifications N, and accordingly may not display an important notification(s) N desired by the user. In recent years, messaging applications and SNS applications, on which a large number of notifications tend to be generated in a short time, have widely spread, and also information-providing applications have been sophisticated and diversified, so that the frequency of generation of notifications has been increasing.

To deal with this, in this embodiment, the CPU 11 of the electronic timepiece 10 determines a notification N that is to be displayed on the display 14 from among notifications N that the short-range wireless communicator 17 has received from the smartphone 20, on the basis of the priority of each of the notifications N determined with a predetermined method, and displays the determined notification N on the display 14. The priority of each of the notifications N is determined on the basis of the user information 132 and/or the user information 232 each related to at least one of the situation and the action history of the user.

For example, the priority of each of the notifications N may be determined on the basis of the movement information 1322 included in the user information 132. The movement information 1322 includes information on the user movement at a point of time at which the CPU 11 estimates the user movement on the basis of the output data of the sensor unit 19 and/or the position information 1321. Types of the user movement to be estimated include, but are not limited to, running, walking, cycling, and pausing (stopping/not moving). These types of movement are estimated on the basis of the amount of change in position per predetermined time (i.e., moving speed), the magnitude and pattern of arm swing detected by the motion sensor 191, change in altitude detected by the pressure sensor 192, and/or the like.

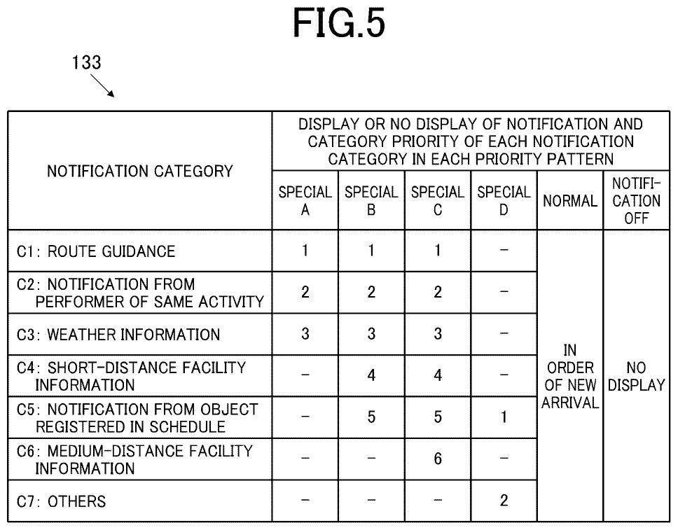

The method for determining the priority of each of the notifications N in accordance with the user movement may be a method of determining, for each type of movement, the priority (category priority) of the category (notification category) of each of the notifications N, and displaying a notification N that belongs to the notification category having the highest category priority among the not-yet-displayed notifications N stored in the notification memory 134 of the electronic timepiece 10. The category priority corresponds to a first priority. Examples of the notification category include notification categories C1 to C7 illustrated in FIG. 5. The notification category C1 is “Route Guidance”, which is a category of notifications N to guide the user along a moving route during an activity that involves movement, such as running. The notification category C2 is “Notification from Performer of Same Activity”, which is a category of notifications N from objects who are performing the activity same as that being performed by the user. The notification category C3 is “Weather Information” based on the user's current position. The notification category C4 is “Short-Distance Facility Information”, which is a category of notifications N from facilities, such as stores, located within a predetermined short-distance area (e.g., 500 m or less) from the user's current position. The notification category C5 is “Notification from Object in Schedule”, which is a category of notifications N from objects related to the schedule of the schedule information 2323. The notification category C6 is “Medium-Distance Facility Information”, which is a category of notifications N from facilities, such as stores, located within a predetermined medium-distance area (e.g., more than 500 m but less than 2 km) from the user's current position. The notification category C7 is “Others”, which is a category of notifications N not belonging to any of the notification categories C1 to C6.

Each type of the user movement is associated with one of priority patterns that are different from one another in combination of category priorities of notification categories. For example, running is associated with a priority pattern “Special A”. In the priority pattern “Special A”, the priorities of the notification categories C1 to C3 of notifications N that the user requires during running are set to “1” to “3”, respectively, and the other notification categories, namely C4 to C7, are set to “-” that indicates not displaying notifications N. Regarding the “priority” in the present specification, a smaller numerical value indicates a higher priority. As another example, walking is associated with a priority pattern “Special B”. During walking, the user has room to check information from facilities located within a short-distance area and notifications from objects related to the user's schedule. Therefore, in the priority pattern “Special B”, the priorities of the notification categories C4 and C5 are set to “4” and “5”, respectively, which is different from the priority pattern “Special A”. If the user movement is running, but the electronic timepiece 10 is not operating in the activity mode, the priority pattern “Special B” may be used for (i.e., associated with) the running by the running being regarded as light running for the user. As another example, cycling is associated with a priority pattern “Special C”. During cycling, the user can easily move to facilities located within a medium-distance area. Therefore, in the priority pattern “Special C”, the priority of the notification category C6 is set to “6”, which is different from the priority pattern “Special B”. As another example, pausing is associated with a priority pattern “Special D”. In the priority pattern “Special D”, the priorities of the notification categories C5 and C7 of notifications N that the user tends to desire to check during pausing are set to “1” and “2”, respectively, and the other notification categories are set to “-”. Types of the user movement other than running, walking, cycling and pausing are associated with a priority pattern “Normal”. In the priority pattern “Normal”, no priorities of notification categories are set, and notifications N are displayed in order of new arrival. The CPU 11 may determine whether the electronic timepiece 10 is worn on the user's wrist on the basis of the output data of the sensor unit 19. If the CPU 11 determines that the electronic timepiece 10 is not worn, a priority pattern “Notification Off” illustrated in FIG. 5 may be applied. When the priority pattern “Notification Off” is applied, no notifications N are displayed on the display 14 in order to reduce power consumption. The contents of each priority pattern illustrated in FIG. 5 are mere examples and can be changed as appropriate. The contents of each priority pattern may be changed in response to user operations.

Separately from the category priority, the individual priority of each of the notifications N may be set. The individual priority corresponds to a second property. The individual priority of each of the notifications N may be used in a case where there are two or more notifications N that belong to the notification category having the highest category priority among the notifications N received from the smartphone 20 but not yet displayed, to determine a notification N that is to be displayed on the display 14 from among the two or more notifications N. The individual priority of each of the notifications N is determined on the basis of one or more types of information included in the user information 132 and the user information 232.

The individual priority of each of the

notifications N may be determined on the basis of the user's current position that is identified with the position information 1321. For example, the individual priority of a notification N associated with a certain position (e.g., a notification N from a store, the notification N being associated with the position of the store) may be determined on the basis of the positional relationship between the user's current position and the certain position. More specifically, the individual priority of a notification N associated with a certain position may be determined to be higher as the user's current position is closer to the certain position. The individual priority of a notification N associated with a certain position may be determined to be higher in a case where the certain position is in the user movement area, which is estimated in accordance with the user movement, than in a case where the certain position is outside the user movement area. The movement area may be calculated by multiplying the moving speed of the user movement by a predetermined time (time length).

If a notification N is related to a contact from a certain object, the individual priority of the notification N may be determined on the basis of the contact frequency between the user and the object, the contact frequency being identified with the contact frequency information 2321. For example, the individual priority of a notification N related to a contact from a certain object may be determined to be higher as the contact frequency between the user and the object is higher. The individual priority of a notification N related to a contact from a certain object may be determined to be higher in a case where the object is performing an activity with the user than in a case where the object is not performing an activity with the user.

If a notification N is from a certain application, the individual priority of the notification N may be determined on the basis of the use frequency of the application, the use frequency being identified with the use frequency information 2322. For example, the individual priority of a notification N from a certain application may be determined to be higher as the use frequency of the application is higher. The individual priority of a notification N from a certain application may be determined on the basis of the use frequency of the application in a time period to which the current time belongs (e.g., within one hour before and after the current time).

If a notification N is related to the schedule of the schedule information 2323, the individual priority of the notification N may be determined to be higher as the notification N is related to an earlier event registered in the schedule.

The individual priority of each of the

notifications N may be determined on the basis of a combination of two or more of the above-described factors, which are the user's current position, the contact frequency with an object, the use frequency of an application, and the user's schedule. It is a matter of course that the individual priority of each of the notifications N may be determined on the basis of a factor(s) other than or in addition to one or more of the above factors.

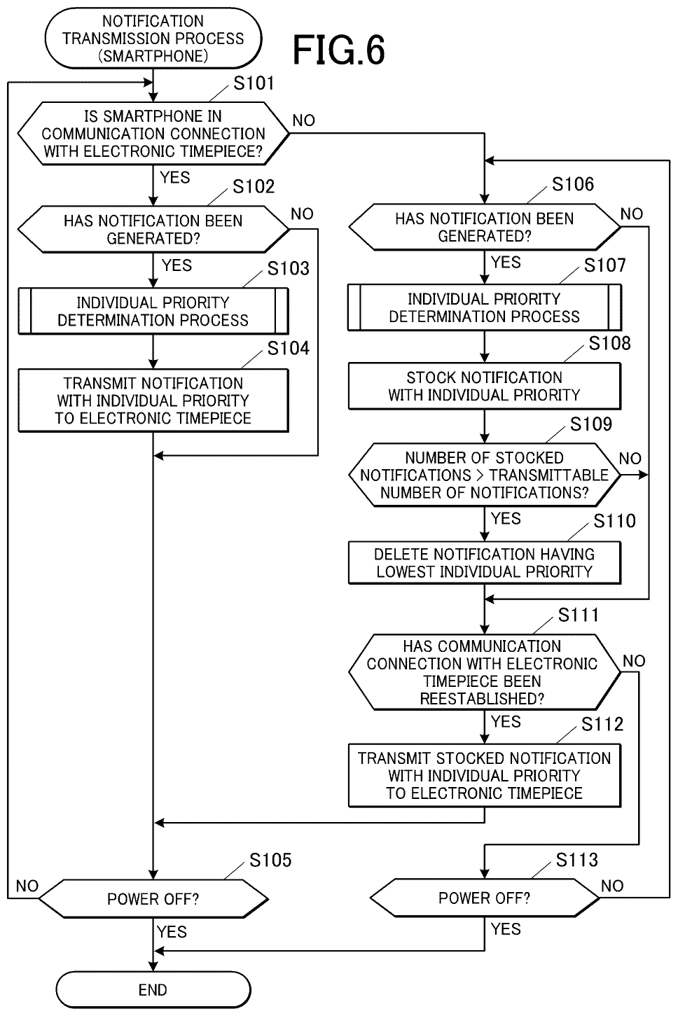

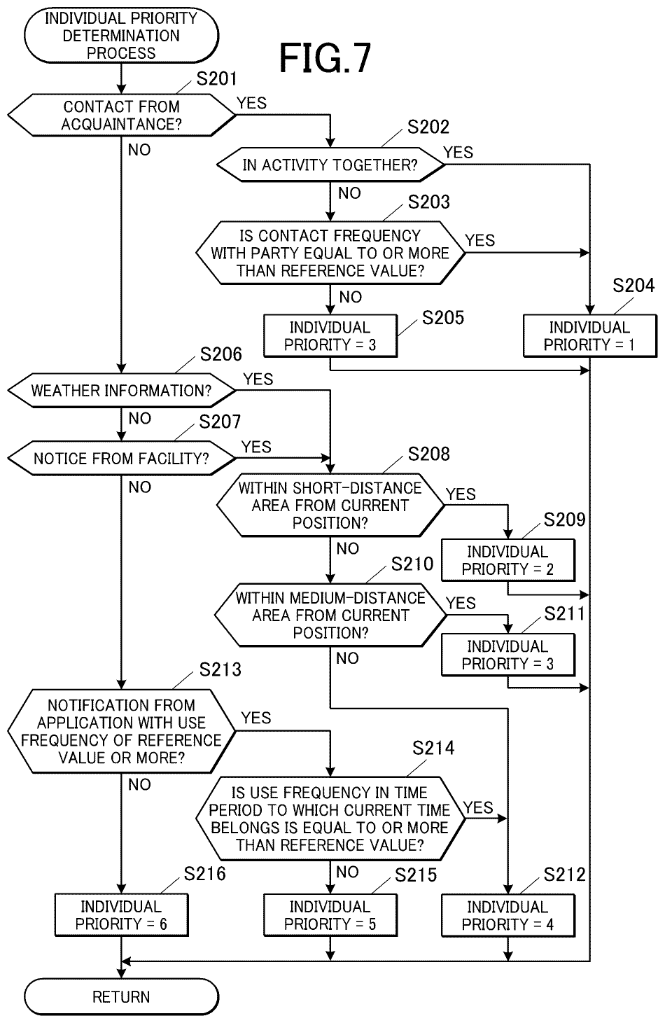

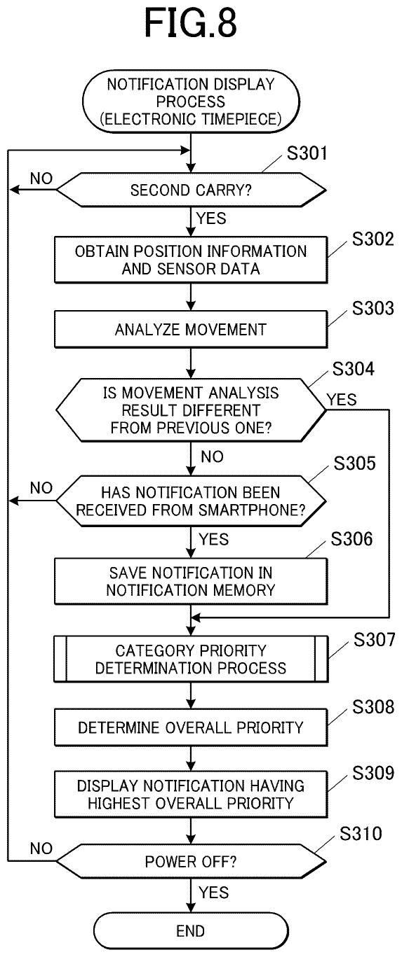

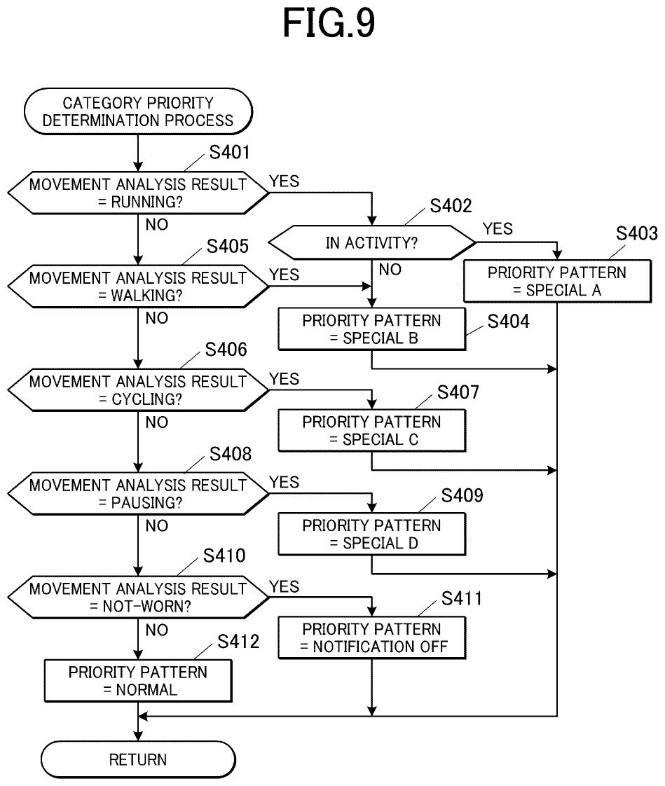

Next, a notification transmission process (FIG. 6 and FIG. 7) that is performed by the CPU 21 of the smartphone 20 and a notification display process (FIG. 8 and FIG. 9) that is performed by the CPU 11 of the electronic timepiece 10 to realize the above-described operation will be described. In this embodiment, the smartphone 20 determines the individual priority of each notification N, the electronic timepiece 10 determines the category priority thereof in accordance with the user movement, and on the basis of the individual priority and the category priority, the electronic timepiece 10 determines the overall priority (third priority) thereof. The method for determining the individual priorities, the category priorities and the overall priorities illustrated in FIG. 6 to FIG. 9 are mere examples and can be changed as appropriate.

The notification transmission process illustrated in FIG. 6 is started when the smartphone 20 starts up. When the notification transmission process is started, the CPU 21 of the smartphone 20 determines whether the smartphone 20 is in communication connection with the electronic timepiece 10 by BLE (Step S101). If the CPU 21 determines that the smartphone 20 is in communication connection with the electronic timepiece 10 (Step S101; YES), the CPU 21 performs Steps S102 to S105 to transmit generated notifications N to the electronic timepiece 10 one by one. In Step S102, the CPU 21 determines whether a notification N has been generated. If the CPU 21 determines that a notification N has been generated (Step S102; YES), the CPU 21 performs an individual priority determination process illustrated in FIG. 7 (Step S103).

When the individual priority determination process is started, the CPU 21 determines whether the generated notification N is related to a contact from an acquaintance (object) (Step S201). If the CPU 21 determines that the notification N is related to a contact from an acquaintance (Step S201; YES), the CPU 21 determines whether the contact, namely the notification N, is a contact from an acquaintance who is performing an activity with the user (Step S202). This kind of notification N may be generated, for example, in a case where they are performing an activity, such as running, together but some distance away from each other, or in a case where they are running in the same marathon. The method for determining whether the contact is a contact from an acquaintance who is performing an activity with the user is not particularly limited, but, for example, may be a method of comparing an activity indicated by status information included in the notification N from the acquaintance with an activity that the user is performing. If the CPU 21 determines that the contact is not a contact from an acquaintance who is performing an activity with the user (Step S202; NO), the CPU 21 refers to the contact frequency information 2321 to determine whether the contact frequency with the party is equal to or more than a predetermined reference value (Step S203). If the CPU 21 determines “YES” in Step S202 or Step S203, the CPU 21 sets the individual priority of the notification N to “1” (Step S204). If the CPU 21 determines “NO” in Step S203, the CPU 21 sets the individual priority of the notification N to “3” (Step S205).

If the CPU 21 determines that the notification N is not related to a contact from an acquaintance (Step S201; NO), the CPU 21 determines whether the notification N is related to weather information (Step S206). If the CPU 21 determines that the notification N is not related to weather information (Step S206; NO), the CPU 21 determines whether the notification N is related to a notice from a facility, such as a store (Step S207). If the CPU 21 determines “YES” in Step S206 or Step S207, the CPU 21 determines whether the notification N corresponds to a position within a predetermined short-distance area (e.g., within 500 m) from the user's current position (Step S208). More specifically, in the case where the CPU 21 determines “YES” in Step S206, the CPU 21 determines that the notification N corresponds to a position within the short-distance area from the user's current position (Step S208; YES) if the user's current position is within the target area of the weather information or the distance between the user's current position and the target area is within the short-distance area from the user's current position. In the case where the CPU 21 determines “YES” in Step S207, the CPU 21 determines that the notification N corresponds to a position within the short-distance area from the current position (Step S208; YES) if the distance between the user's current position and the facility is within the short-distance area from the user's current position. If the CPU 21 determines that the notification N corresponds to a position within the short-distance area from the user's current position (Step S208; YES), the CPU 21 sets the individual priority of the notification N to “2” (Step S209). If the CPU 21 determines that the notification N does not correspond to a position within the short-distance area from the user's current position (Step S208; NO), the CPU 21 determines whether the notification N corresponds to a position within a predetermined medium-distance area from the user's current position (e.g., more than 500 m but less than 2 km) (Step S210). If the CPU 21 determines that the notification N corresponds to a position within the medium-distance area from the user's current position (Step S210; YES), the CPU 21 sets the individual priority of the notification N to “3” (Step S211). If the CPU 21 determines that the notification N does not correspond to a position within the medium-distance area from the user's current position (Step S210; NO), the CPU 21 sets the individual priority of the notification N to “4” (Step S212).

If the CPU 21 determines that the notification N is not related to a notice from a facility (Step S207; NO), the CPU 21 refers to the use frequency information 2322 to determine whether the notification N is from an application the use frequency of which is equal to or more than a predetermined reference value (Step S213). If the CPU 21 determines that the notification N is from an application the use frequency of which is equal to or more than the predetermined reference value (Step S213; YES), the CPU 21 determines whether the use frequency in a time period to which the current time belongs is equal to or more than the reference value (Step S214). If the CPU 21 determines that the use frequency in the time period is equal to or more than the reference value (Step S214; YES), the CPU 21 sets the individual priority of the notification N to “4” (Step S212). If the CPU 21 determines that the use frequency in the time period is less than the reference value (Step S214; NO), the CPU 21 sets the individual priority of the notification N to “5” (Step S215).

If the CPU 21 determines that the notification N is not from an application the use frequency of which is equal to or more than the predetermined reference value (Step S213; NO), the CPU 21 sets the individual priority of the notification N to “6” (Step S216). When any of Steps S204, S205, S209, S211, S212, S215 and S216 finishes, the CPU 21 ends the individual priority determination process and returns the process to the notification transmission process illustrated in FIG. 6.

In the individual priority determination process in FIG. 7, depending on the contents of a notification N, an individual priority (e.g., “0”) that indicates not displaying notifications N on the electronic timepiece 10 may be assigned to the notification N. For example, an individual priority of “0” may be assigned to a notification N related to a spam mail. As another example, an individual priority of “0” may be assigned to a notification N that the smartphone 20 wants to receive but the electronic timepiece 10 does not need to receive, such as a notification N from a specific application.

Returning to FIG. 6, when the individual priority determination process (Step S103) finishes, the CPU 21 transmits data of the notification N with information on the individual priority attached to the electronic timepiece 10 (Step S104). When Step S104 finishes or the CPU 21 determines that no notification N has been generated in Step S102 (Step S102; NO), the CPU 21 determines whether an operation to power off the smartphone 20 has been made (Step S105). If the CPU 21 determines that no such operation has been made (Step S105; NO), the CPU 21 returns the process to Step S101. If the CPU 21 determines that the operation has been made (Step S105; YES), the CPU 21 ends the notification transmission process.

If the CPU 21 determines in Step S101 that the smartphone 20 is not in communication connection with the electronic timepiece 10 (Step S101; NO), the CPU 21 performs Steps S106 to S113 to stock generated notifications N, and transmits the stocked notifications N to the electronic timepiece 10 when the communication connection is reestablished.

In Step S106, the CPU 21 determines whether a notification N has been generated. If the CPU 21 determines that a notification N has been generated (Step S106; YES), the CPU 21 performs, for the notification N, the individual priority determination process illustrated in FIG. 7 (Step S107). When the individual priority determination process finishes, the CPU 21 stocks data of the notification N with information on the determined individual priority attached in the storage 23 (Step S108). The CPU 21 determines whether the number of stocked notifications N is more than a transmittable number of notifications N (Step S109). The transmittable number of notifications N is determined according to the storage capacity of the notification memory 134 of the electronic timepiece 10. In this embodiment, it is ten. If the CPU 21 determines that the number of stocked notifications N is more than the transmittable number of notifications N (Step S109; YES), the CPU 21 deletes a notification N having the lowest individual priority among the stocked notifications N (Step S110).

When Step S110 finishes or the CPU 21 determines in Step S106 that no notification N has been generated (Step S106; NO), the CPU 21 determines whether the communication connection with the electronic timepiece 10 has been reestablished (Step S111). If the CPU 21 determines that the communication connection with the electronic timepiece 10 has been reestablished (Step S111; YES), the CPU 21 transmits data of the stocked notifications N (up to ten notifications N) with their individual priorities attached to the electronic timepiece 10 (Step S112) and advances the process to Step S105. If the CPU 21 determines that the communication connection with the electronic timepiece 10 has not been reestablished (Step S111; NO), the CPU 21 determines whether an operation to power off the smartphone 20 has been made (Step S113). If the CPU 21 determines that no such operation has been made (Step S113; NO), the CPU 21 returns the process to Step S106. If the CPU 21 determines that the operation has been made (Step S113; YES), the CPU 21 ends the notification transmission process.

Although FIG. 6 illustrates an example in which all notifications N are transmitted to the electronic timepiece 10 regardless of their individual priorities unless the number of notifications N exceeds the transmittable number of notifications N, a notification(s) N the value of the individual priority of which is equal to or larger than a predetermined value (e.g., a notification N having an individual priority of “6”) may not be transmitted to the electronic timepiece 10. The manner in which all notifications N are transmitted to the electronic timepiece 10 is suitable, for example, for the case where notifications N are transmitted with Apple Notification Center Service (ANCS) in iOS. The manner in which some notifications N are extracted and transmitted to the electronic timepiece 10 can be realized, for example, by the smartphone 20 that is an Android® OS smartphone. Notifications N that have not been transmitted to the electronic timepiece 10 may be transmitted to the electronic timepiece 10 after a certain time elapses.

Next, a control procedure for the aforementioned notification display process that is performed by the electronic timepiece 10 will be described with reference to FIG. 8 and FIG. 9. The notification display process illustrated in FIG. 8 is started when the electronic timepiece 10 starts up. When the notification display process is started, the CPU 11 of the electronic timepiece 10 repeatedly determines whether a second carry has been detected, namely whether it is the timing, which comes once per second, to update an indication of seconds (Step S301). Instead of the second carry, a ten-second carry, a one-minute carry or the like may be used.

If the CPU 11 determines that a second carry has been detected (Step S301; YES), the CPU 11 obtains information on the current position of the electronic timepiece 10 and the user from the position information obtaining unit 18 and records the information in the position information 1321, and also obtains output data of each sensor of the sensor unit 19 (Step S302). The CPU 11 analyzes the user movement on the basis of the data obtained in Step S302 and records the identified movement in the movement information 1322 (Step S303). In Step S303, the CPU 11 estimates the user movement (running, walking, cycling, pausing, or the like) on the basis of the amount of change in current position per predetermined time (speed), the magnitude and pattern of arm swing detected by the motion sensor 191, change in altitude detected by the pressure sensor 192, and/or the like. If the electronic timepiece 10 has not moved for a certain time according to the output data of the sensor unit 19, the CPU 11 determines that the electronic timepiece 10 is not worn by the user. If the ascent (ups) and descent (downs) of the route are not to be determined, the output data of the pressure sensor 192 may be omitted. The CPU 11 may transmit the information on the current position obtained in Step S302 and the information on the user movement identified in Step S303 to the smartphone 20. The smartphone 20 may refer to these pieces of information in the next and/or subsequent individual priority determination process(es).

The CPU 11 determines whether the result of the movement analysis is different (has changed) from the result of the previous movement analysis (Step S304). If the CPU 11 determines that the result of the movement analysis is not different from the result of the previous movement analysis (Step S304; NO), the CPU 11 determines whether a new notification N has been received from the smartphone 20 (Step S305). If the CPU 11 determines that no new notification N has been received (Step S305; NO), the CPU 11 returns the process to Step S301. If the CPU 11 determines that a new notification N has been received (Step S305; YES), the CPU 11 saves data of the received notification N in the notification memory 134 (Step S306). At the time, if a savable number of notifications N (ten notifications N in this embodiment) are already saved in the notification memory 134, the CPU 11 deletes the oldest notification N from the notification memory 134. When Step S306 finishes or the CPU 11 determines that the result of the movement analysis is different from the result of the previous movement analysis (Step S304;

YES), the CPU 11 performs a category priority determination process (Step S307) illustrated in FIG. 9.

When the category priority determination process is started, the CPU 11 determines whether the result of the movement analysis (i.e., user's current movement recorded in the movement information 1322) is running (Step S401). If the CPU 11 determines that the result of the movement analysis is running (Step S401; YES), the CPU 11 determines whether the user is performing an activity (Step S402). For example, the CPU 11 determines that the user is performing an activity if the electronic timepiece 10 is operating in the activity mode. If the CPU 11 determines that the user is performing an activity (Step S402; YES), the CPU 11 determines the “Special A” illustrated in FIG. 5 as the priority pattern, which is relevant to category priorities (Step S403). If the CPU 11 determines that the user is not performing an activity (Step S402; NO), the CPU 11 determines the “Special B” as the priority pattern (Step S404).

If the CPU 11 determines that the result of the movement analysis is not running (Step S401; NO), the CPU 11 determines whether the result of the movement analysis is walking (Step S405). If the CPU 11 determines that the result of the movement analysis is walking (Step S405; YES), the CPU 11 determines the “Special B” as the priority pattern (Step S404).

If the CPU 11 determines that the result of the movement analysis is not walking (Step S405; NO), the CPU 11 determines whether the result of the movement analysis is cycling (Step S406). If the CPU 11 determines that the result of the movement analysis is cycling (Step S406; YES), the CPU 11 determines the “Special C” as the priority pattern (Step S407).

If the CPU 11 determines that the result of the movement analysis is not cycling (Step S406; NO), the CPU 11 determines whether the result of the movement analysis is pausing (Step S408). If the CPU 11 determines that the result of the movement analysis is pausing (Step S408; YES), the CPU 11 determines the “Special D” as the priority pattern (Step S409).

If the CPU 11 determines that the result of the movement analysis is not pausing (Step S408; NO), the CPU 11 determines whether the result of the movement analysis is not-worn, namely indicates that the electronic timepiece 10 is not worn (Step S410). If the CPU 11 determines that the result of the movement analysis is not-worn (Step S410; YES), the CPU 11 determines the “Notification Off” as the priority pattern (Step S411).

If the CPU 11 determines that the result of the movement analysis is not not-worn (Step S410; NO), the CPU 11 determines the “Normal” as the priority pattern (Step S412). When any of Steps S403, S404, S407, S409, S411 and S412 finishes, the CPU 11 ends the category priority determination process and returns the process to the notification display process illustrated in FIG. 8.

Returning to FIG. 8, when the category priority determination process in Step S307 finishes, the CPU 11 determines the overall priorities of the notifications N stored in the notification memory 134 at that time on the basis of the individual priorities attached to the notifications N and the category priorities set in the priority pattern determined in Step S307 (Step S308). The CPU 11 displays, on the display 14, the notification N having the highest overall priority among the notifications N (Step S309). If a displayable number of notifications N displayable at a time on the display 14 is two or three, the CPU 11 selects two or three notifications N in order of overall priority from the top and displays the selected notifications N on the display 14.

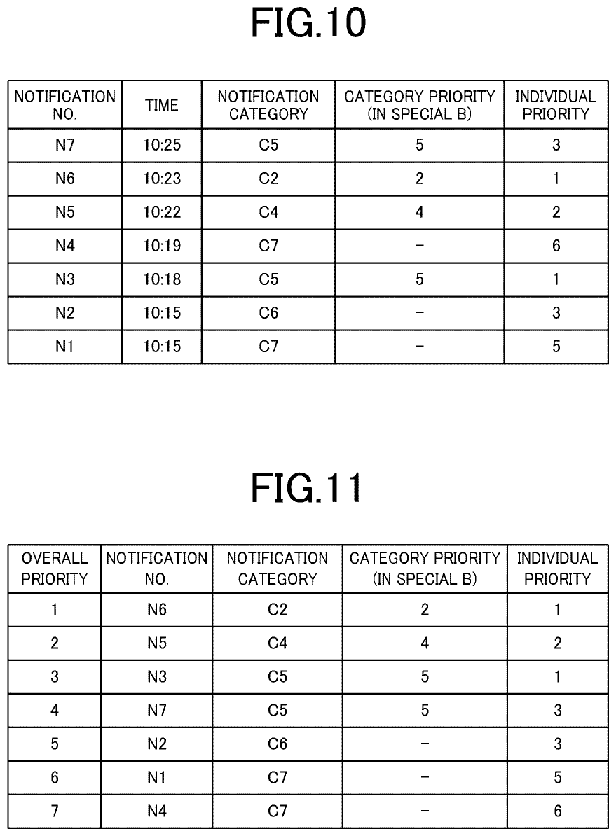

With reference to FIG. 10 and FIG. 11, an example of how to determine the overall priorities of the notifications N in Step S308 will be described. Assume that at a point of time, notifications N1 to N7 illustrated in FIG. 10 are stored in the notification memory 134. Of these, the notification N1 is the oldest, and the notification N7 is the newest/latest. The notification categories of the notifications N1 to N7 are as illustrated in FIG. 10. Assume that the “Special B” has been determined as the priority pattern by the category priority determination process. According to the priority pattern “Special B”, the category priorities of the notification categories to which the notifications N1 to N7 belong are as illustrated in FIG. 10. To the notifications N1 to N7, the individual priorities illustrated in the rightmost column of FIG. 10 are attached. The overall priorities of the notifications N1 to N7 in this case are as illustrated in FIG. 11. In FIG. 11, the notifications N1 to N7 are sorted in order of overall priority. The overall priorities of the notifications N1 to N7 are determined, for example, by order of arrangement of the notifications N1 to N7 determined by sorting the notifications N1 to N7 in descending order of category priority, and if notifications N having the same category priority are present, sorting these in descending order of individual priority within the same notification category. Furthermore, if two or more notifications N belong to the same notification category and have the same individual priority, the one generated at a more recent time may have a higher overall priority. In the example illustrated in FIG. 11, the notification N6, which has the highest category priority of “2” among the notifications N1 to N7, has the highest overall priority. Therefore, in Step S309, the CPU 11 displays the notification N6 on the display 14.

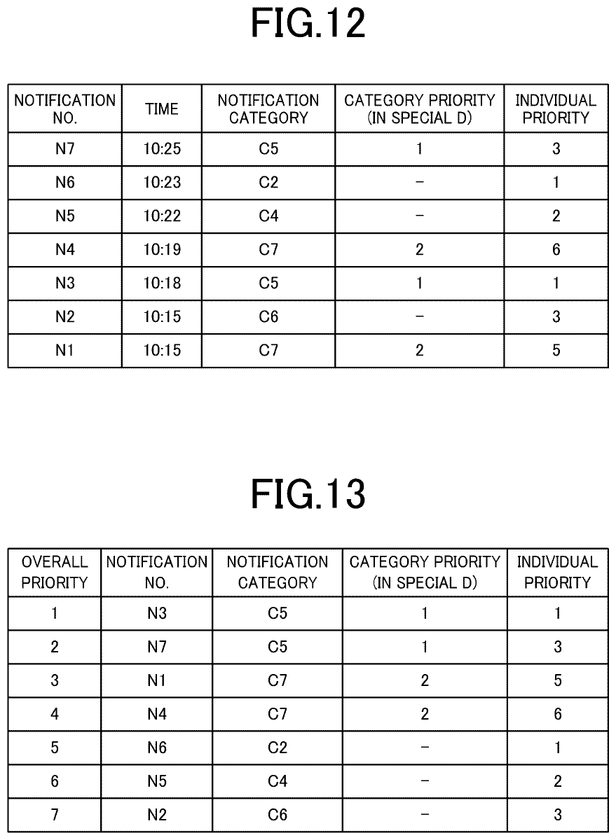

If the “Special D” is determined as the priority pattern in the state in which the same notifications N1 to N7 as those illustrated in FIG. 10 are stored in the notification memory 134, the category priorities of the notifications N1 to N7 are as illustrated in FIG. 12. In this case, the overall priorities of the notifications N1 to N7 are determined as illustrated in FIG. 13. In the example illustrated in FIG. 13, the notification N3, which has both the highest category priority of “1” and the highest individual priority of “1”, has the highest overall priority.

The method for determining the overall priorities of notifications N using the category priorities and the individual priorities thereof is not limited to the above-described method. For example, the overall priorities of notifications N may be determined by sorting the notifications N in order of individual priority first, and if notifications N having the same individual priority are present, sorting these in order of category priority. The overall priority of each notification N may be calculated with a predetermined calculation method using the value of its category priority and the value of its individual priority. For example, the overall priority of a notification N may be higher as the sum of the value of its category priority and the value of its individual priority is smaller.

The notification N displayed in Step S309 may be hidden after a predetermined time elapses, or may be made to continue to be displayed until the user makes a predetermined check-done operation. Detailed contents of the notification N may be displayed on the display 14 if the user makes a predetermined operation while the notification N is displayed. When Step S309 finishes, the CPU 11 determines whether an operation to power off the electronic timepiece 10 has been made (Step S310). If the CPU 11 determines that no such operation has been made (Step S310; NO), the CPU 11 returns the process to Step S301. If the CPU 11 determines that the operation has been made (Step S310; YES), the CPU 11 ends the notification display process.

If the electronic timepiece 10 does not display a notification N on the display 14 within a certain time after receiving the notification N, the electronic timepiece 10 may exclude the notification N from a list of display targets in the notification display process. However, the notification N excluded from the list of display targets may be stored in the notification memory 134, and displayed on the display 14 when the user makes a predetermined operation. In this case, among the notifications N saved in the notification memory 134, the notifications N that have not been excluded from the list of display targets are subjected to the notification display process. This can prevent push notification of notifications N that have been left/saved for a certain time or more since they were generated. The notification N displayed on the display 14 in Step S309 may be deleted from the notification memory 134, or may be left in the notification memory 134 but excluded from the list of display targets in the notification display process.

According to the notification display process in FIG. 8, not only when the CPU 11 determines in Step S305 that a notification N has been received, but also when the CPU 11 determines in Step S304 that the result of the movement analysis is different from the result of the previous movement analysis, the CPU 11 determines the category priority of the notification N in Step S307, determines the overall priorities of the notifications N stored at the time in Step S308, and displays a notification N in Step S309. Thus, calculation of the overall priorities of notifications N can be performed by being triggered by change in movement of the user, change in position of the user, the start or end of an event registered in the schedule of the schedule information 2323, and/or the like. Therefore, the most appropriate notification N at a point of time at which any of these triggers occurs can be displayed.

Next, the aforementioned second embodiment of the present disclosure will be described. Hereinafter, differences from the first embodiment will be described, and descriptions of contents common to the first embodiment will be omitted. In the second embodiment, the smartphone 20 determines the individual priority of each notification N using the machine-learned model 233. The machine-learned model 233 has been machine-learned to output the individual priority of a generated notification by receiving data of the notification. The machine-learned model 233 has been machine-learned with training data that includes data of notifications N generated in the past, user information at points of time at which the notifications N were generated, and information on importance levels of the notifications N. The user information used as the training data may include at least part (or one) of the position information 1321, the movement information 1322, the contact frequency information 2321, the use frequency information 2322, and the schedule information 2323. The information on the importance levels of the notifications N used as the training data may be information generated such that the importance level of a notification N was high if the user had made a predetermined action or the like (e.g., an operation to display its detailed information) to the notification N. As an example, the machine-learned model 233 may have been machine-learned to output the individual priority of each notification N, the individual priority being the same as or similar to that output by the individual priority determination process illustrated in FIG. 7. At an early stage, a learned model (library) that has been trained to some extent may be used, and this learned model may be made to additionally learn the personal information on the user. The machine-learned model 233 may be prepared for each category of notifications N (e.g., alert, incoming call, email, message, notification from application, etc., in addition to the notification categories described in the first embodiment). That is, a plurality of machine-learned models 233 may be prepared. The machine-learned model 233 is not particularly limited in configuration, but may use, for example, a neural network or a support vector machine. The machine-learned model 233 may be provided in an external device that is a separate device from both the smartphone 20 and the electronic timepiece 10. In this case, the CPU 21 of the smartphone 20 transmits data of notifications N to the external device to cause the machine-learned model 233 to output the individual priorities of the notifications N, and receives the output results from the external device.

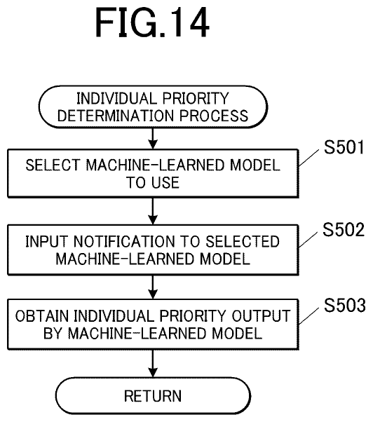

In the individual priority determination process in the second embodiment, as illustrated in FIG. 14, the CPU 21 of the smartphone 20 selects a machine-learned model 233 to use, in accordance with the category of a generated notification N (Step S501). Next, the CPU 21 inputs data of the notification N to the selected machine-learned model 233 (Step S502). Then, the CPU 21 obtains the individual priority output by the machine-learned model 233 (Step S503) and ends the individual priority determination process.

As described above, there is a known technology of an electronic device having a display, such as a wristwatch, displaying the latest notification received from an external communication device, such as a smartphone, on the display. However, a user desired notification changes depending on the situation and/or the action history of the user. The conventional method of simply displaying the latest notification does not always provide the user with his/her desired notification. Meanwhile, according to the above embodiments of the present disclosure, the effects described below can be obtained. The electronic timepiece 10 of the above embodiments includes the display 14, the short-range wireless communicator 17 that communicates with the external smartphone 20, and the CPU 11. The CPU 11 determines a notification N that is to be displayed on the display 14 from among notifications N received by the short-range wireless communicator 17 from the smartphone 20 on the basis of the priority (individual priority, category priority, and overall priority) of each of the notifications N, the priority being determined on the basis of the user information 132 and/or the user information 232 each related to at least one of the situation and the action history of the user of the electronic timepiece 10. The CPU 11 displays the determined notification N on the display 14. Thus, an appropriate notification N can be selected and displayed on the basis of at least one of the situation and the action history of the user. For example, a notification N at a point of time can be displayed by being estimated as a notification required by the user from the movement, the position and/or the like of the user, namely the situation of the user, at the point of time and histories of these, and/or the action history of the user. Thus, a user desired notification N can be appropriately selected and displayed on the small display 14 of the electronic timepiece 10. A user desired notification N can be displayed without taking time or effort to do On/Off notification setting for each application. Furthermore, selecting and displaying a notification N having a high priority can reduce power consumption of the electronic timepiece 10.

Furthermore, the CPU 11 displays the determined notification N on the display 14 such that the determined notification N occupies at least half of the display area of the display 14. Even in such a restriction-imposed case, the method of the above embodiments can be used to display an appropriate, user desired notification N.

Furthermore, the user information 132 includes the movement information 1322 on the movement of the user, the movement being identified on the basis of at least one of the output data of the sensor unit 19 as the motion information on the motion of the user and the position information 1321 on the position of the user. The category priority of each of the notifications N is determined on the basis of the movement information 1322. Thus, a notification N required by the user in the movement can be displayed preferentially.

Furthermore, the priority of each of the notifications N includes the category priority that is related to the category of each of the notifications N and determined on the basis of the movement information 1322, and the individual priority determined for each of the notifications N on the basis of the user information 132 and/or the user information 232. The CPU 11 determines, as the notification N to be displayed on the display 14, a notification N the category priority of which is highest among the notifications N. In response to two or more notifications N each being the notification the category priority of which is highest being present, the CPU 11 determines, as the notification N to be displayed on the display 14, a notification N the individual priority of which is highest among the two or more notifications N. Thus, a notification N of a category required by the user in the movement can be displayed preferentially on the basis of the movement of the user, and further, a notification N estimated to be more/most desired by the user within the same category can be displayed preferentially.

Furthermore, the user information 132 may include the position information 1321 on the position of the user. The priority of a notification N associated with a certain position may be determined to be higher in the case where the certain position is in the movement area of the user, the movement area being estimated in accordance with the movement, than in the case where the certain position is outside the movement area of the user. Thus, an appropriate notification N for the movement area of the user, the movement area being estimated from the movement, can be selected and displayed.

Furthermore, the user information 132 may include the position information 1321 on the position of the user. The priority of a notification N associated with a certain position may be determined on the basis of the positional relationship between the position information 1321 included in the user information 132 and the certain position. Thus, an appropriate notification N for the position of the user can be selected and displayed.

Furthermore, the user information 232 may include the contact frequency information 2321 on the contact frequency between an (each) object and the user. The individual priority of a notification N related to a contact from the object to the user may be determined on the basis of the contact frequency information 2321. Thus, a notification N from an object with whom the user is in frequent contact can be displayed preferentially.

Furthermore, the user information 232 may include the use frequency information 2322 on the use frequency of an (each) application program by the user. The individual priority of a notification N related to the application program may be determined on the basis of the use frequency information 2322. Thus, a notification N from an application program that the user frequently uses can be displayed preferentially.

Furthermore, the user information 232 may include the schedule information 2323 on the schedule of the user. The individual priority and/or the category priority of a notification N related to the schedule may be determined to be higher as the notification N is related to an earlier event in the schedule of the schedule information 2323. Thus, a notification N required by the user according to the user's schedule can be displayed preferentially.

Furthermore, in the above embodiments, the method that is performed by the CPU 11 of the electronic timepiece 10 is disclosed. With this method, the CPU 11 determines a notification N that is to be displayed on the display 14 from among notifications N received by the short-range wireless communicator 17 from the smartphone 20 on the basis of the priority (individual priority, category priority, and overall priority) of each of the notifications N, the priority being determined on the basis of the user information 132 and/or the user information 232 each related to at least one of the situation and the action history of the user of the electronic timepiece 10. The CPU 11 displays the determined notification N on the display 14. Thus, a user desired notification N can be appropriately selected and displayed on the small display 14 of the electronic timepiece 10.

Furthermore, the storage 13 of the above embodiments is the non-transitory storage medium storing the programs 131 readable by the CPU 11 of the electronic timepiece 10. The program(s) 131 causes the CPU 11 to determine a notification N that is to be displayed on the display 14 from among notifications N received by the short-range wireless communicator 17 from the smartphone 20 on the basis of the priority (individual priority, category priority, and overall priority) of each of the notifications N, the priority being determined on the basis of the user information 132 and/or the user information 232 each related to at least one of the situation and the action history of the user of the electronic timepiece 10. The program(s) 131 causes the CPU 11 to display the determined notification N on the display 14. Thus, a user desired notification N can be appropriately selected and displayed on the small display 14 of the electronic timepiece 10.

The present disclosure is not limited to the above embodiments and can be modified in a variety of aspects. For example, in the above embodiments, the position information obtained by the position information obtaining unit 18 and the output data of the sensor unit 19, which are both provided in the electronic timepiece 10, are used to identify the situation (position and movement) of the user, but this is not a limitation. For example, a component equivalent to the sensor unit 19 may be provided in the smartphone 20, and the position information obtaining unit 28 and this sensor-unit-equivalent component of the smartphone 20 may be used to identify the situation of the user. As another example, some or all of the position information obtaining unit 18 and the sensor unit 19 of the electronic timepiece 10 and the position information obtaining unit 28 and the sensor unit of the smartphone 20 may be used to identify the situation of the user.

Furthermore, in the above embodiments, the smartphone 20 determines the individual priorities of notifications N, and the electronic timepiece 10 determines the category priorities and the overall priorities thereof, but this is not a limitation. Either of the electronic timepiece 10 and the smartphone 20 may determine the individual priorities, the category priorities and/or the overall priorities of notifications N.

Furthermore, the category priorities may be omitted, and the overall priorities may be determined solely on the basis of the individual priorities. For example, the overall priorities of notifications N may be determined by sorting the notifications N in order of individual priority, and if notifications N having the same individual priority are present, the overall priority of a more recent notification N among these may be made higher. Alternatively, the individual priorities may be omitted, and the overall priorities may be determined solely on the basis of the category priorities. For example, the overall priorities of notifications N may be determined by sorting the notifications N in order of category priority, and if notifications N having the same category priority are present, the overall priority of a more recent notification N among these may be made higher.

Furthermore, in the above embodiments, the electronic timepiece 10 is the electronic device, and the smartphone 20 is the communication device, but this is not a limitation. The electronic device may be a small wearable device, such as a sensing device that detects the motion of the body or an activity tracker, or may be a device having a limited display area, such as a calculator or an electronic dictionary. The communication device may be any device as far as it is capable of data communication with the electronic device.

Furthermore, in the above, the flash memories of the storages 13 and 23 are each the computer-readable medium storing the programs of the present disclosure, but this is not a limitation. The computer-readable medium may be an information recording/storage medium, such as a hard disk drive (HDD), a solid state drive (SSD) or a CD-ROM. In addition, carrier waves are applicable to the present disclosure as a medium that provides data of the programs of the present disclosure via a communication line.

It is a matter of course that the detailed configuration and the detailed operation of each component of the electronic timepiece 10 and the smartphone 20 in the above embodiments can be changed as appropriate within the range of not departing from the scope of the present disclosure.

Although some embodiments of the present disclosure have been described above, the scope of the present disclosure is not limited to the embodiments but includes the scope of claims and their equivalents.

1. An electronic device comprising:
a display;
a communicator that communicates with an external communication device; and
at least one processor that
determines a notification that is to be displayed on the display from among notifications received by the communicator from the external communication device based on a priority of each of the notifications, the priority being determined based on user information related to a situation and/or an action history of a user of the electronic device, and
displays the determined notification on the display.

2. The electronic device according to claim 1, wherein the processor displays the determined notification on the display such that the determined notification occupies at least half of a display area of the display.

3. The electronic device according to claim 2,
wherein the user information includes movement information on a movement of the user, the movement being identified based on motion information on a motion of the user and/or position information on a position of the user, and
wherein the priority of each of the notifications is determined based on the movement information included in the user information.

4. The electronic device according to claim 3,
wherein the priority of each of the notifications includes a first priority that is related to a category of each of the notifications and determined based on the movement information, and a second priority that is determined for each of the notifications based on the user information, and
wherein the processor
determines, as the notification to be displayed on the display, a notification the first priority of which is highest among the notifications, and
in response to two or more notifications each being the notification the first priority of which is highest being present, determines, as the notification to be displayed on the display, a notification the second priority of which is highest among the two or more notifications.

5. The electronic device according to claim 3,
wherein the user information includes the position information on the position of the user, and
wherein the priority of, among the notifications, a notification associated with a certain position is determined to be higher in a case where the certain position is in a movement area of the user, the movement area being estimated in accordance with the movement, than in a case where the certain position is outside the movement area of the user.

6. The electronic device according to claim 2,
wherein the user information includes position information on a position of the user, and
wherein the priority of, among the notifications, a notification associated with a certain position is determined based on a positional relationship between the position information included in the user information and the certain position.

7. The electronic device according to claim 2,
wherein the user information includes contact frequency information on a contact frequency between an object and the user, and
wherein the priority of, among the notifications, a notification related to a contact from the object to the user is determined based on the contact frequency information included in the user information.

8. The electronic device according to claim 2,
wherein the user information includes use frequency information on a use frequency of an application program by the user, and
wherein the priority of, among the notifications, a notification related to the application program is determined based on the use frequency information included in the user information.

9. The electronic device according to claim 2,
wherein the user information includes schedule information on a schedule of the user, and
wherein the priority of, among the notifications, a notification related to the schedule is determined to be higher as the notification is related to an earlier event in the schedule of the schedule information.

10. A method that is performed by a computer of an electronic device including a display and a communicator that communicates with an external communication device, the method comprising:
determining a notification that is to be displayed on the display from among notifications received by the communicator from the external communication device based on a priority of each of the notifications, the priority being determined based on user information related to a situation and/or an action history of a user of the electronic device; and
displaying the determined notification on the display.

11. The method according to claim 10, wherein the displaying includes displaying the determined notification on the display such that the determined notification occupies at least half of a display area of the display.

12. The method according to claim 11,
wherein the user information includes movement information on a movement of the user, the movement being identified based on motion information on a motion of the user and/or position information on a position of the user, and
wherein the priority of each of the notifications is determined based on the movement information included in the user information.

13. The method according to claim 12,
wherein the priority of each of the notifications includes a first priority that is related to a category of each of the notifications and determined based on the movement information, and a second priority that is determined for each of the notifications based on the user information, and
wherein the determining includes:
determining, as the notification to be displayed on the display, a notification the first priority of which is highest among the notifications, and
in response to two or more notifications each being the notification the first priority of which is highest being present, determining, as the notification to be displayed on the display, a notification the second priority of which is highest among the two or more notifications.

14. The method according to claim 12,
wherein the user information includes the position information on the position of the user, and
wherein the priority of, among the notifications, a notification associated with a certain position is determined to be higher in a case where the certain position is in a movement area of the user, the movement area being estimated in accordance with the movement, than in a case where the certain position is outside the movement area of the user.

15. The method according to claim 11,
wherein the user information includes position information on a position of the user, and
wherein the priority of, among the notifications, a notification associated with a certain position is determined based on a positional relationship between the position information included in the user information and the certain position.

16. The method according to claim 11,
wherein the user information includes contact frequency information on a contact frequency between an object and the user, and
wherein the priority of, among the notifications, a notification related to a contact from the object to the user is determined based on the contact frequency information included in the user information.

17. The method according to claim 11,
wherein the user information includes use frequency information on a use frequency of an application program by the user, and
wherein the priority of, among the notifications, a notification related to the application program is determined based on the use frequency information included in the user information.

18. The method according to claim 11,
wherein the user information includes schedule information on a schedule of the user, and
wherein the priority of, among the notifications, a notification related to the schedule is determined to be higher as the notification is related to an earlier event in the schedule of the schedule information.

19. A non-transitory storage medium storing a program readable by a computer of an electronic device including a display and a communicator that communicates with an external communication device, the program causing the computer to:
determine a notification that is to be displayed on the display from among notifications received by the communicator from the external communication device based on a priority of each of the notifications, the priority being determined based on user information related to a situation and/or an action history of a user of the electronic device; and
display the determined notification on the display.
